(19) United States
(12) Patent Application Publication
(10) Pub. No.: US 2015/0057423 A1
(43) Pub. Date: Feb. 26, 2015

(54) Polycarbonate-Polysiloxane Copolymer, and Method for Preparing Same

(71) Applicant: Cheil Industries Inc., Gumi-si, Gyeongsangbuk-do (KR)

(72) Inventors: Jeung Gon Kim, Uiwang-si (KR); Jung Woo Park, Uiwang-si (KR); Chang Hong Ko, Uiwang-si (KR); Tae Joon Park, Uiwang-si (KR); Hong Gi Ahn, Uiwang-si (KR)

(73) Assignee: Cheil Industries Inc., Kumi-city, Kyungsangbuk-do (KR)

(21) Appl. No.: 14/384,735

(22) PCT Filed: Oct. 26, 2012
(86) PCT No.: PCT/KR2012/008879

§ 371 Date: Sep. 12, 2014

(30) Foreign Application Priority Data
Mar. 13, 2012 (KR) 10-2012-0025711

(51) Int. Cl. C08G 64/06

(52) U.S. Cl. CPC C08G 64/06
USPC 528/29

(57) ABSTRACT

The present invention relates to a polycarbonate-polysiloxane copolymer containing a polysiloxane unit. The polycarbonate-polysiloxane copolymer of the present invention includes an aliphatic terminal having a specific carbon number, thereby having excellent impact properties at low temperature, and high transparency.

### TECHNICAL FIELD

The present invention relates to a polycarbonate-polysiloxane copolymer and a method for preparing the same. More particularly, the present invention relates to a polycarbonate-polysiloxane copolymer exhibiting excellent impact strength at low temperature and high transparency by virtue of an introduced aliphatic terminal having a specific carbon number.

### BACKGROUND ART

Polycarbonates are a transparent thermoplastic and high performance plastic material exhibiting desirable mechanical, optical, thermal and electrical properties. However, polycarbonates need greater impact strength in order to be used in various applications.

In order to improve mechanical properties of polycarbonates, it has been proposed to blend polycarbonates with other materials. However, when polycarbonates are blended with other materials, phase separation often occurs due to difference in solubility, thereby causing deterioration in intrinsic transparency of the polycarbonates. For example, studies on physically mixing the polycarbonate with a siloxane monomer have been performed in order to improve impact, melt flow and mold release properties of the polycarbonate. In this case, however, the polycarbonate can suffer from drastic deterioration in transparency even with small amount of siloxane, thereby making it difficult to realize expression of various colors recently required for resins.

In copolymerization, which is a chemical mixing method, at least two kinds of monomer units are polymerized to improve physical properties. In this case, since the obtained polymer can have physical properties exhibited by each monomer unit, this copolymerization method can be used in the preparation of high performance polycarbonates. By way of example, polycarbonate-polysiloxane copolymers are known to have improved ductility, processability, weather resistance, impact resistance after coating, and the like while maintaining high transparency.

However, existing polycarbonates still lack in impact strength at low temperature and have transparency deteriorating with increasing silicone content.

Therefore, there is a need for a copolymer including a carbonate unit and a siloxane unit having excellent impact strength at low temperature while maintaining high transparency and low haze.

### DISCLOSURE

### Technical Problem

It is one aspect of the present invention to provide a polycarbonate-polysiloxane copolymer having excellent impact strength at low temperature while maintaining high transparency and low haze, and a method for preparing the same.

It is another aspect of the present invention to provide a polycarbonate-polysiloxane copolymer having excellent balance of physical properties while maintaining a high reaction participation rate, and a method for preparing the same.

### Technical Solution

One aspect of the present invention relates to a polycarbonate-polysiloxane copolymer. The polycarbonate-polysiloxane copolymer contains a polysiloxane unit represented by Formula 1:

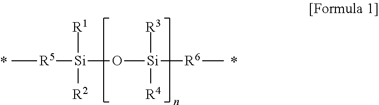

(wherein R¹, R², R³ and R⁴ are each independently a substituted or unsubstituted C₁ to C₁₀ alkyl group, a substituted or unsubstituted C₆ to C₁₈ aryl group, a C₁ to C₁₀ alkyl group substituted with a halogen or a C₁ to C₁₀ alkoxy group, or a C₆ to C₁₈ aryl group substituted with a halogen or a C₁ to C₁₀ alkoxy group; R⁵ and R⁶ are each independently a C₃ to C₈ alkylene group; n is an integer from about 20 to about 100; and * is a linking group of a polycarbonate unit).

In one embodiment, the polycarbonate-polysiloxane copolymer may have a haze value of about 11% or less on a 2.5 mm thick specimen in a silicone content of about 1 wt % to about 4 wt %, and an impact strength of about 40 kgf cm/cm or more at −20° C. and about 30 kgf cm/cm or more at −50° C., respectively, as measured on a ⅛″ thick specimen in accordance with ASTM D256.

In one embodiment, the polysiloxane unit may not contain an ether group in a backbone thereof.

In one embodiment, the polysiloxane unit may not contain an arylene group in the backbone thereof.

In one embodiment, the polycarbonate-polysiloxane copolymer may have a weight average molecular weight of about 15,000 g/mol to about 50,000 g/mol.

Another aspect of the present invention relates to a method for preparing a polycarbonate-polysiloxane copolymer. The method includes polymerization by introducing an aromatic dihydroxy compound and a phosgene-based compound into a polysiloxane represented by Formula 2:

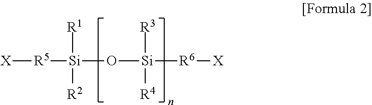

(wherein R¹, R², R³ and R⁴ are each independently a substituted or unsubstituted C₁ to C₁₀ alkyl group, a substituted or unsubstituted C₆ to C₁₈ aryl group, a C₁ to C₁₀ alkyl group substituted with a halogen or a C₁ to C₁₀ alkoxy group, or a C₆ to C₁₈ aryl group substituted with a halogen or a C₁ to C₁₀ alkoxy group; R⁵ and R⁶ are each independently a C₃ to C₈ alkylene group; X is a hydroxyl group, an amine group or an epoxy group; and n is an integer from about 20 to about 100).

In one embodiment, X is a hydroxyl group.

In one embodiment, the aromatic dihydroxy compound may be introduced in an amount of about 99.9 parts by weight to about 80.0 parts by weight relative to about 0.1 parts by weight to about 20.0 parts by weight of polysiloxane.

### Advantageous Effects

The present invention provides a polycarbonate-polysiloxane copolymer having excellent impact strength at low temperature, high reaction participation rate, and excellent balance of physical properties while maintaining high transparency and low haze, and a method for preparing the same.

### DESCRIPTION OF DRAWINGS

FIG. 1 shows a nuclear magnetic resonance (NMR) photograph of a polycarbonate-polysiloxane copolymer prepared in Example 1.

FIG. 2 shows an NMR photograph of a polycarbonate-polysiloxane copolymer prepared in Comparative Example 1.

### BEST MODE

Embodiments of the present invention will now be described in detail.

A polycarbonate-polysiloxane copolymer according to the present invention contains a polysiloxane unit represented by Formula 1:

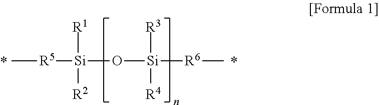

wherein R¹, R², R³ and R⁴ are each independently a substituted or unsubstituted C₁ to C₁₀ alkyl group, a substituted or unsubstituted C₆ to C₁₈ aryl group, a C₁ to C₁₀ alkyl group substituted with a halogen or a C₁ to C₁₀ alkoxy group, or a C₆ to C₁₈ aryl group substituted with a halogen or a C₁ to C₁₀ alkoxy group; R⁵ and R⁶ are each independently a C₃ to C₈ alkylene group; n is an integer from about 20 to about 100; and * is a site to which a polycarbonate unit is linked (linking group).

As used herein, the term “substituted” means that at least one hydrogen atom is substituted with a halogen, a hydroxyl group, a nitro group, a cyano group, an amino group, an azido group, an amidino group, a hydrazino group, a carbonyl group, a carbamyl group, a thiol group, an ester group, a carboxyl group or salt thereof, a sulfonate group or salt thereof, a phosphate group or salt thereof, a C₁ to C₂₀ alkyl group, a C₂ to C₂₀ alkenyl group, a C₂ to C₂₀ alkynyl group, a C₁ to C₂₀ alkoxy group, a C₆ to C₃₀ aryl group, a C₆ to C₃₀ aryloxy group, a C₃ to C₃₀ cycloalkyl group, a C₃ to C₃₀ cycloalkenyl group, a C₃ to C₃₀ cycloalkynyl group, or combinations thereof.

In the present invention, R⁵ and R⁶ are a C₃ to C₈ alkylene group. When the carbon number is less than 3, there is a concern that the reaction participation rate can be decreased. When the carbon number is greater than 8, there is a concern that impact strength can be decreased. Preferably, R⁵ and R⁶ are a C₃ to C₆ alkylene group. R⁵ and R⁶ may be linear or branched.

“n” is an integer from about 20 to about 100, preferably from about 25 to about 90, more preferably from about 30 to about 70. Within this range, the polycarbonate exhibits good transparency.

The polysiloxane unit is present in an amount of about 0.1 wt % to about 20.0 wt %, preferably about 5.0 wt % to about 15.0 wt %, in the backbone of the polycarbonate-polysiloxane copolymer. Within this range, the polycarbonate exhibits good transparency.

The polycarbonate-polysiloxane copolymer may be prepared by a method for preparing a polycarbonate-polysiloxane copolymer according to the present invention. For example, the polycarbonate-polysiloxane copolymer may be obtained by polymerization by introducing an aromatic dihydroxy compound and a phosgene-based compound into a polysiloxane represented by Formula 2:

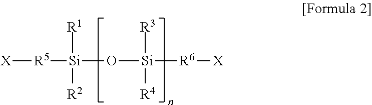

wherein R¹, R², R³ and R⁴ are each independently a substituted or unsubstituted C₁ to C₁₀ alkyl group, a substituted or unsubstituted C₆ to C₁₈ aryl group, a C₁ to C₁₀ alkyl group substituted with a halogen or a C₁ to C₁₀ alkoxy group, or a C₆ to C₁₈ aryl group substituted with a halogen or a C₁ to C₁₀ alkoxy group; R⁵ and R⁶ are each independently a C₃ to C₈ alkylene group; X is a hydroxyl group, an amine group or an epoxy group; and n is an integer from about 20 to about 100.

X is preferably a hydroxyl group.

In one embodiment, the polysiloxane unit may not contain an ether group in the backbone thereof. In this case, the polycarbonate has a high reaction participation rate and secures excellent transparency, as compared with polycarbonates containing the same silicone content.

In another embodiment, the polysiloxane unit may not contain an arylene group in the backbone thereof. In this case, the polycarbonate may have further improved impact strength at low temperature.

Examples of the phosgene-based compound may include phosgene, triphosgene, diphosgene, and the like. The phosgene-based compound may be added in the same amount as in the case of preparing a typical polycarbonate-polysiloxane copolymer, without being limited thereto.

The aromatic dihydroxy compound is added in an amount of about 99.9 parts by weight to about 80.0 parts by weight, preferably about 99.0 parts by weight to about 75 parts by weight, relative to about 0.1 parts by weight to about 20.0 parts by weight, preferably about 1.0 part by weight to 15.0 parts by weight of the polysiloxane. Within this range, the polycarbonate can have excellent transparency.

The aromatic dihydroxy compound may be represented by Formula 3:

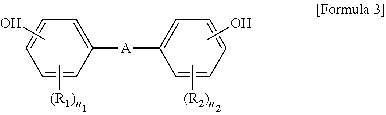

wherein A is a single bond, a substituted or unsubstituted C₁ to C₃₀ linear or branched alkylene group, a substituted or unsubstituted C₂ to C₅ alkenylene group, a substituted or unsubstituted C₂ to C₅ alkylidene group, a substituted or unsubstituted C₁ to C₃₀ linear or branched haloalkylene group, a substituted or unsubstituted C₅ to C₆ cycloalkylene group, a substituted or unsubstituted C₅ to C₆ cycloalkenylene group, a substituted or unsubstituted C₅ to C₁₀ cycloalkylidene group, a substituted or unsubstituted C₆ to C₃₀ arylene group, a substituted or unsubstituted C₁ to C₂₀ linear or branched alkoxylene group, a halogen acid ester group, S, or SO₂; R₁ and R₂ are the same or different and are a substituted or unsubstituted C₁ to C₃₀ alkyl group or a substituted or unsubstituted C₆ to C₃₀ aryl group; and n₁ and n₂ are each an integer from 0 to 4.

Examples of the aromatic dihydroxy compound represented by Formula 3 may include 4,4′-dihydroxydiphenyl, 2,2-bis-(4-hydroxyphenyl)-propane, 2,4-bis-(4-hydroxyphenyl)-2-methylbutane, 1,1-bis-(4-hydroxyphenyl)-cyclohexane, 2,2-bis-(3-chloro-4-hydroxyphenyl)-propane, and 2,2-bis-(3,5-dichloro-4-hydroxyphenyl)-propane, without being limited thereto. Among these aromatic dihydroxy compounds, 2,2-bis-(4-hydroxyphenyl)-propane, 2,2-bis-(3,5-dichloro-4-hydroxyphenyl)-propane, 1,1-bis-(4-hydroxyphenyl)-cyclohexane, and the like are preferred, and 2,2-bis-(4-hydroxyphenyl)-propane which is also called “bisphenol-A” is most preferred.

In one embodiment, the polycarbonate-polysiloxane copolymer may be prepared through interfacial polymerization by adding an aromatic dihydroxy compound to a basic aqueous solution, followed by adding and mixing an organic solvent and a polysiloxane represented by Formula 2, and then adding a phosgene-based compound. With such interfacial polymerization, the polycarbonate can exhibit remarkably improved transparency as compared with polycarbonates prepared by melt polymerization.

The prepared polycarbonate-polysiloxane copolymer includes the polysiloxane unit represented by Formula 1 in the backbone thereof, and exhibits excellent transparency, and excellent impact resistance at room temperature and low temperature.

The polycarbonate-polysiloxane copolymer according to the present invention has a haze value of about 11% or less, preferably from about 0.1% to about 10.5%, more preferably from about 1% to about 3%, as measured on a 2.5 mm thick specimen, in a silicone content of about 1 wt % to about 4 wt %.

The polycarbonate-polysiloxane copolymer has an impact strength of about 30 kgf cm/cm or more, preferably about 40 kgf cm/cm or more, more preferably about 45 kgf cm/cm or more, as measured on a ⅛″ thick specimen at about −50° C. in accordance with ASTM D256. For example, the polycarbonate-polysiloxane copolymer may have an impact strength of about 48 kgf cm/cm to about 90 kgf cm/cm under these conditions.

The polycarbonate-polysiloxane copolymer has an impact strength of about 40 kgf cm/cm or more, preferably about 45 kgf cm/cm or more, more preferably about 50 kgf cm/cm or more, as measured on a ⅛″ thick specimen at about −20° C. in accordance with ASTM D256. For example, the polycarbonate-polysiloxane copolymer may have an impact strength of about 52 kgf cm/cm to about 100 kgf cm/cm under these conditions.

In addition, the polycarbonate-polysiloxane copolymer has an impact strength of about 55 kgf cm/cm or more, preferably about 60 kgf cm/cm or more, as measured on a ⅛″ thick specimen at room temperature in accordance with ASTM D256. For example, the polycarbonate-polysiloxane copolymer may have an impact strength of about 60 kgf cm/cm to about 120 kgf cm/cm under these conditions.

The polycarbonate-polysiloxane copolymer has a weight average molecular weight from about 15,000 g/mol to about 50,000 g/mol, preferably from about 19,000 g/mol to about 40,000 g/mol, as measured by gel permeation chromatography (GPC).

### MODE FOR INVENTION

Hereinafter, the present invention will be described in more detail with reference to the following examples. It should be understood that these examples are provided for illustration only and are not to be construed in any way as limiting the scope of the present invention.

### EXAMPLE

### Example 1

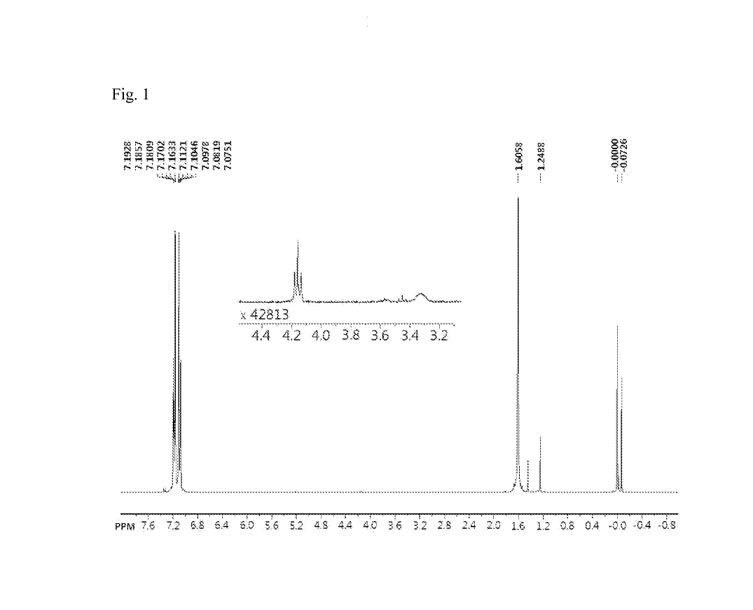

To a 20 L glass reactor, 50 wt % NaOH was mixed with 7 L of distilled water by stirring. To the obtained mixture, 1.50 kg of bisphenol-A was added. After the temperature of the solution became 22° C. or less, 3 L of methylene chloride, 41.5 g of t-butyl phenol, and 118 g of a siloxane compound represented by Formula 2-1 were added and vigorously stirred. To this stirred solution, a solution prepared by dissolving 974 g of triphosgene in 3 L of methylene chloride was added at a rate of 60 mL/minute. It was observed that there was an increase in reaction temperature. When the reaction temperature decreased to 23° C. or less after 1 hour, 7.80 g of triethylamine was added to the solution, and the temperature of the reactor was kept at 30° C. or more. After stirring the solution for 2 hours, the separated organic layer was washed with a mixed solution of 6 L of water and 10 mL of 50 wt % NaOH once, a mixed aqueous solution of 6 L of water and 60 mL of 35% HCl once, and 12 L of distilled water twice. To the organic layer, a methanol solution having the same volume ratio was added while slowly stirring the organic layer in a stirrer over 1 hour, thereby forming a white precipitate. The precipitate was separated by filtration, followed by drying at 80° C. for 12 hours, thereby obtaining 1.5 kg of a polycarbonate-polysiloxane copolymer. DOSY (diffusion ordered spectroscopy) and ¹H NMR analysis of the polymer showed that a siloxane polymer bonded to a backbone of the polycarbonate was present. ¹H NMR analysis showed that the Si content was 2.02 wt %. ¹H NMR results are depicted in FIG. 1. GPC analysis showed that the weight average molecular weight (Mw) was 21,300 g/mol. An integrated value of at 3.45 ppm of an unreacted PDMS (polydimethylsiloxane) monomer and 4.18 ppm of a copolymerized PDMS monomer on ¹H NMR spectrum showed that 93% of terminal hydroxyl groups participated in the copolymer.

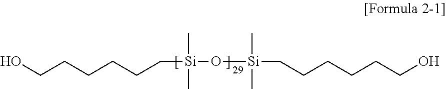 [SMILES: C[Si](C)(CCCCCCO)O[Si](C)(C)CCCCCCO]

### Example 2

The same procedure as in Example 1 was performed except that a siloxane compound represented by Formula 2-2 was used instead of the siloxane compound represented by Formula 2-1. Finally, 1.5 kg of a polycarbonate-polysiloxane copolymer was obtained. DOSY and ¹H NMR analysis of the polymer showed that a siloxane polymer bonded to a backbone of the polycarbonate was present. ¹H NMR analysis showed that the Si content was 2.12 wt % and GPC analysis showed that Mw was 22,300 g/mol. An integrated value of 3.45 ppm of an unreacted PDMS monomer and 4.18 ppm of a copolymerized PDMS monomer on ¹H NMR spectrum showed that 95% of terminal hydroxyl groups participated in the copolymer.

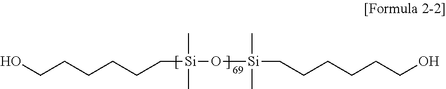 [SMILES: C[Si](C)(CCCCCCO)O[Si](C)(C)CCCCCCO]

### Example 3

The same procedure as in Example 1 was performed except that a siloxane compound represented by Formula 2-3 was used instead of the siloxane compound represented by Formula 2-1. Finally, 1.5 kg of a polycarbonate-polysiloxane copolymer was obtained. DOSY and ¹H NMR analysis of the polymer showed that a siloxane polymer bonded to a backbone of the polycarbonate was present, and ¹H NMR analysis showed that the Si content was 2.10 wt %. GPC analysis showed that Mw was 20,600 g/mol. An integrated value of 3.60 ppm of an unreacted PDMS monomer and 4.20 ppm of a copolymerized PDMS monomer on ¹H NMR spectrum showed that 88% of terminal hydroxyl groups participated in the copolymer.

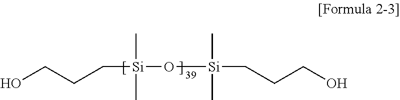

### Comparative Example 1

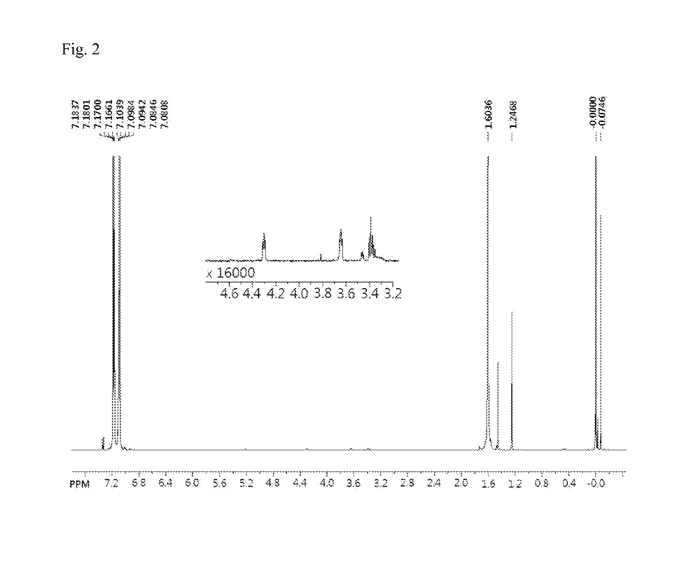

The same procedure as in Example 1 was performed except that 117 g of a polysiloxane compound having a terminal —OH group represented by Formula 4 was used instead of the siloxane compound represented by Formula 2-1. Finally, 1.5 kg of a polycarbonate-polysiloxane copolymer was obtained. DOSY and ¹H NMR analysis of the polymer showed that a siloxane polymer bonded to a backbone of the polycarbonate was present, and ¹H NMR analysis showed that the Si content was 1.68 wt %. ¹H NMR results are depicted in FIG. 2. GPC analysis showed that Mw was 21,000 g/mol. An integrated value of 3.47 ppm of an unreacted PDMS monomer and 4.30 ppm of a copolymerized PDMS monomer on ¹H NMR spectrum showed that 77% of terminal hydroxyl groups participated in the copolymer.

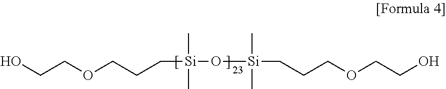 [SMILES: C[Si](C)(CCCOCCO)O[Si](C)(C)CCCOCCO]

### Comparative Example 2

The same procedure as in Example 1 was performed except that 117 g of a polysiloxane compound having a terminal —OH group represented by Formula 5 was used instead of the siloxane compound represented by Formula 2-1. Finally, 1.5 kg of a polycarbonate-polysiloxane copolymer was obtained. DOSY and ¹H NMR analysis of the polymer showed that a siloxane polymer bonded to a backbone of the polycarbonate was present, and ¹H NMR analysis showed that the Si content was 1.75 wt %. GPC analysis showed that Mw was 21,800 g/mol. An integrated value of 3.47 ppm of an unreacted PDMS monomer and 4.30 ppm of a copolymerized PDMS monomer on ¹H NMR spectrum showed that 71% of terminal hydroxyl groups participated in the copolymer.

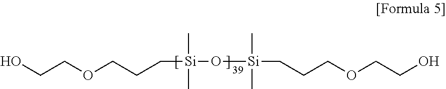 [SMILES: C[Si](C)(CCCOCCO)O[Si](C)(C)CCCOCCO]

### Comparative Example 3

The same procedure as in Example 1 was performed except that 107 g of a polysiloxane compound having a terminal —OH group represented by Formula 6 was used instead of the siloxane compound represented by Formula 2-1. Finally, 1.5 kg of a polycarbonate-polysiloxane copolymer was obtained. DOSY and ¹H NMR analysis of the polymer showed that a siloxane polymer bonded to a backbone of the polycarbonate was present, and ¹H NMR analysis showed that the Si content was 1.58 wt %. GPC analysis showed that Mw was 22,400 g/mol. An integrated value of 3.47 ppm of an unreacted PDMS monomer and 4.30 ppm of a copolymerized PDMS monomer on ¹H NMR spectrum showed that 71% of terminal hydroxyl groups participated in the copolymer.

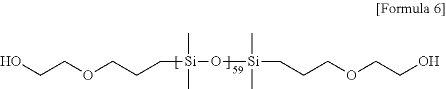 [SMILES: C[Si](C)(CCCOCCO)O[Si](C)(C)CCCOCCO]

### Comparative Example 4

A polycarbonate SC-1190 manufactured by Cheil Industries Inc. in which a siloxane was not copolymerized was used in evaluation.

### Comparative Example 5

The same procedure as in Example 1 was performed except that 100 g of a polysiloxane compound having a terminal —OH group represented by Formula 8 was used instead of the siloxane compound represented by Formula 2-1. Finally, 1.5 kg of a polycarbonate-polysiloxane copolymer was obtained. DOSY and ¹H NMR analysis of the polymer showed that a siloxane polymer bonded to a backbone of the polycarbonate was present, and ¹H NMR analysis showed that the Si content was 1.57 wt %. GPC analysis showed that Mw was 19,500 g/mol. An integrated value of 3.50 ppm of an unreacted PDMS monomer and 4.35 ppm of a copolymerized PDMS monomer on ¹H NMR spectrum showed that 65% of terminal hydroxyl groups participated in the copolymer.

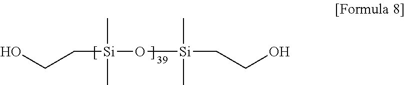

The copolymers prepared in Examples and Comparative Examples were dried at 120° C. for 4 hours, followed by injection molding in a 10 Oz. injection molding device at a molding temperature of 250° C. to 290° C. and a mold temperature of 70° C., thereby preparing specimens. The physical properties of the specimens were measured as follows. Results are shown in Table 1.

Method for Measuring Physical Properties

(1) Weight average molecular weight (unit: g/mol): The weight average molecular weight was measured using GPC (manufactured by ViscoTek Co., Ltd.) in accordance with PS standard.

(2) Si content (unit: wt %): The Si content was measured using a 300 MHz Topspin NMR (manufactured by Bruker Co., Ltd.).

(3) Impact resistance (unit: kgf cm/cm): Impact resistance was measured at room temperature, −20° C. and −50° C., respectively, using notched ¼″ and ⅛″ Izod specimens in accordance with ASTM D256.

(4) Haze and Transparency (unit: %): Haze and transparency were measured on 2.5 mm thick specimens using a haze meter (YDP02-0D) manufactured by Nippon Denshoku Co., Ltd.

TABLE 1

| | | | Reaction | | | Impact properties | | | |
|---|---|---|---|---|---|---|---|---|---|
| | | Si | Participa- | Molecular | | (IZOD) | | | |
| | Si | content | tion rate | weight | Haze | | | ⅛″ | ⅛″ |
| | No. | (wt %) | (%) | (Mw) | (%) | ¼″ | ⅛″ | (−20° C.) | (−50° C.) |
| Example 1 | 30 | 2.02 | 93 | 21,300 | 1.44 | 38 | 68 | 53 | 49 |
| Example 2 | 70 | 2.12 | 95 | 22,300 | 10.4 | 45 | 60 | 58 | 56 |
| Example 3 | 40 | 2.10 | 88 | 20,600 | 2.15 | 40 | 67 | 55 | 53 |
| Comparative | 24 | 1.68 | 77 | 21,000 | 8.40 | 59 | 58 | 54 | 22 |
| Example 1 | | | | | | | | | |
| Comparative | 40 | 1.75 | 71 | 21,800 | 11.0 | 48 | 61 | 55 | 49 |
| Example 2 | | | | | | | | | |
| Comparative | 60 | 1.58 | 71 | 22,400 | 63 | 49 | 64 | 63 | 55 |
| Example 3 | | | | | | | | | |
| Comparative | — | — | — | 22,200 | 0.20 | 6.7 | 73 | 6.1 | — |
| Example 4 | | | | | | | | | |
| Comparative | 40 | 1.57 | 65 | 19,500 | 12.0 | 40 | 58 | 49 | 42 |
| Example 5 | | | | | | | | | |

In Table 1, it could be seen that the polycarbonate-polysiloxane copolymer according to the present invention exhibited remarkably improved impact strength as compared with the polycarbonate according to Comparative Example 4 in which siloxane was not copolymerized. In addition, the copolymer of Comparative Example 1 containing an ether group in the backbone exhibited decreased impact strength at −50° C. Further, when comparing Example 3 with Comparative Examples 2 and 5, which have identical Si No., it could be seen that the polycarbonate-polysiloxane copolymer of Example 3 showed excellent reaction participation rate, remarkably decreased haze, and excellent impact properties at low temperature. In the case of Comparative Example 3, which has high Si No., it could be seen that haze was remarkably increased, as compared with Example 2.

Although some embodiments have been disclosed herein, it should be understood by those skilled in the art that the present invention is not limited to these embodiments and may be implemented in various ways, and that various modifications, changes, and alterations can be made without departing from the spirit and scope of the invention. Therefore, it should be understood that these embodiments are provided by way of illustration only and are not to be construed in any way as limiting the present invention.

1. A polycarbonate-polysiloxane copolymer comprising a polysiloxane unit represented by Formula 1: 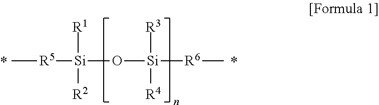
wherein R¹, R², R³ and R⁴ are each independently a substituted or unsubstituted C1 to C10 alkyl group, a substituted or unsubstituted C6 to C18 aryl group, a C1 to C10 alkyl group substituted with a halogen or a C1 to C10 alkoxy group, or a C6 to C18 aryl group substituted with a halogen or a C1 to C10 alkoxy group; R⁵ and R⁶ are each independently a C3 to C8 alkylene group; n is an integer from about 20 to about 100; and * is a linking group of a polycarbonate unit.

2. The polycarbonate-polysiloxane copolymer according to claim 1, wherein the polycarbonate-polysiloxane copolymer has a haze value of about 11% or less on a 2.5 mm thick specimen in a silicone content of about 1 wt % to about 4 wt %, and an impact strength of about 40 kgf cm/cm or more at −20° C. and about 30 kgf cm/cm or more at −50° C., respectively, as measured on a ⅛″ thick specimen in accordance with ASTM D256.

3. The polycarbonate-polysiloxane copolymer according to claim 1, wherein the polysiloxane unit does not contain an ether group in a backbone thereof.

4. The polycarbonate-polysiloxane copolymer according to claim 1, wherein the polysiloxane unit does not contain an arylene group in a backbone thereof.

5. The polycarbonate-polysiloxane copolymer according to claim 1, wherein the polycarbonate-polysiloxane copolymer has a weight average molecular weight of about 15,000 g/mol to about 50,000 g/mol.

6. A method for preparing a polycarbonate-polysiloxane copolymer, comprising: polymerizing by introducing an aromatic dihydroxy compound and a phosgene-based compound into a polysiloxane represented by Formula 2: 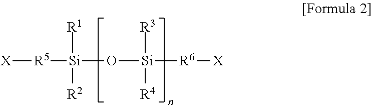
wherein R¹, R², R³ and R⁴ are each independently a substituted or unsubstituted C1 to C10 alkyl group, a substituted or unsubstituted C6 to C18 aryl group, a C1 to C10 alkyl group substituted with a halogen or a C1 to C10 alkoxy group, or a C6 to C18 aryl group substituted with a halogen or a C1 to C10 alkoxy group; R⁵ and R⁶ are each independently a C3 to C8 alkylene group; X is a hydroxyl group, an amine group or an epoxy group; and n is an integer from about 20 to about 100.

7. The method for preparing a polycarbonate-polysiloxane copolymer according to claim 6, wherein X is a hydroxyl group.

8. The method for preparing a polycarbonate-polysiloxane copolymer according to claim 6, wherein the aromatic dihydroxy compound is introduced in an amount of about 99.9 parts by weight to about 80.0 parts by weight relative to about 0.1 parts by weight to about 20.0 parts by weight of polysiloxane.
